(19) United States
(12) Patent Application Publication
(10) Pub. No.: US 2026/0214766 A1
(43) Pub. Date: Jul. 23, 2026

(54) POWER MANAGEMENT DEVICE

(71) Applicant: LX SEMICON CO., LTD., Daejeon (KR)

(72) Inventors: Won Suk JANG, Daejeon (KR); Tae Kyu NAM, Daejeon (KR); Jong Hyun YOON, Daejeon (KR); In Ho JEON, Daejeon (KR)

(73) Assignee: LX SEMICON CO., LTD., Daejeon (KR)

(21) Appl. No.: 19/141,721

(22) PCT Filed: Dec. 20, 2023
(86) PCT No.: PCT/KR2023/021053

§ 371 Date: Jun. 20, 2025

(30) Foreign Application Priority Data
Dec. 21, 2022 (KR) 10-2022-0181067
Dec. 19, 2023 (KR) 10-2023-0185868

(51) Int. Cl. H05B 45/395; G05F 1/575; H05B 45/40

(52) U.S. Cl. CPC H05B 45/395; G05F 1/575; H05B 45/40

(57) ABSTRACT

The power management device disclosed in the embodiment may include: a level shift circuit; a gate driver; a power stage circuit connected to the gate driver and configured to convert power required for a load to output an output voltage; a control circuit configured to control an operation of each component; a first low drop-out regulator configured to adjust a first input voltage to a first output voltage and output the first output voltage to the gate driver; a second low drop-out regulator configured to adjust a second input voltage to a second output voltage and output the second output voltage as a power source for the control circuit; a feedback voltage selector configured to select an input voltage of at least one of the first and second low drop-out regulators according to an external voltage or battery voltage and a level of the output voltage of the power stage circuit; and a switch configured to switch and select from among the external voltage or battery voltage and the output voltage fed back from the power stage circuit in response to a selection signal of the feedback voltage selector.

### TECHNICAL FIELD

The embodiment relates to a power management device. The embodiment relates to a power management device having a low drop-out regulator that reuses internal voltage.

### BACKGROUND ART

A low drop-out (LDO) regulator is a device for providing a stable voltage. The low drop-out regulator is a linear regulator that provides an output voltage lower than the input voltage.

The low drop-out regulator has a power loss because the output voltage is lower than the input voltage, but can provide a stable output voltage. In addition, the low drop-out regulator has excellent characteristics of line regulation and load regulation, and is used in many fields such as power management integrated circuits (power management ICs).

### DISCLOSURE

### Technical Problem

The embodiment provides a power management device having a regulator that reuses the output voltage of the power management device.

The embodiment provides a power management device capable of selecting the input voltage of each of the low drop-out regulators from among the feedback voltages of the power management device.

The embodiment provides a power management device capable of sensing the levels of voltages in the power management device and providing the sensed voltages to the input terminal of each of the low drop-out regulators.

The embodiment provides a power management device capable of improving low operating characteristics and reducing power consumption by reusing the output voltage of the components as the input voltage of the low drop-out regulator.

### Technical Solution

The power management device according to the embodiment comprises: a level shift circuit; a gate driver; a power stage circuit connected to the gate driver and configured to convert power required for a load to output an output voltage; a control circuit configured to control an operation of each component; a first low drop-out regulator configured to adjust a first input voltage to a first output voltage and output the first output voltage to the gate driver; a second low drop-out regulator configured to adjust a second input voltage to a second output voltage and output the second output voltage as a power source for the control circuit; a feedback voltage selector configured to select an input voltage of at least one of the first and second low drop-out regulators according to an external voltage or battery voltage and a level of the output voltage of the power stage circuit; and a switch configured to switch and select from among the external voltage or battery voltage and the output voltage fed back from the power stage circuit in response to a selection signal of the feedback voltage selector.

According to an embodiment, the second input voltage of the second low drop-out regulator may be the output voltage fed back from the power stage circuit, and may have a voltage lower than a level of the external voltage.

According to an embodiment, the feedback voltage selector may control the switch to set a rising time of the second output voltage of the second low drop-out regulator as an input time of the external voltage or the battery voltage.

According to an embodiment, the feedback voltage selector may control the switch to set a falling time of the second output voltage of the second low drop-out regulator as an end time of the external voltage or the battery voltage.

According to an embodiment, the output voltage fed back from the power stage circuit may be a first voltage higher than the level of the external voltage, and the switch may comprise a first switch configured to select one of the external voltage and the first voltage by the feedback voltage selector and may provide the selected one as the first input voltage of the first low drop-out regulator.

According to an embodiment, the output voltage of the power stage circuit may be a second voltage lower than the level of the external voltage and a level of the first voltage, and the switch may comprise a second switch configured to select one of the external voltage and the second voltage by the feedback voltage selector and may provide the selected one as the second input voltage of the second low drop-out regulator.

According to an embodiment, the second voltage may be 1.8 V or less, and a level difference between the second voltage and an operating voltage of the control circuit may be 0.5 V or less.

According to an embodiment, the output voltage of the power stage circuit may be a first voltage lower than a level of the battery voltage, and the switch may comprise a first switch configured to select one of the battery voltage and the first voltage by the feedback voltage selector and may provide the selected one as the first input voltage of the first low drop-out regulator.

According to an embodiment, the output voltage fed back from the power stage circuit may be a second voltage lower than the level of the battery voltage and a level of the first voltage, the switch may comprise a second switch configured to select one of the battery voltage and the second voltage by the feedback voltage selector and is configured to provide the selected one as a second input voltage of the second low drop-out regulator, and the second voltage may be 1.8 V or less, and a level difference between the second voltage and the operating voltage of the control circuit may be 0.5 V or less.

A power management device according to an embodiment may comprise: a level shift circuit; a gate driver; a power stage circuit connected between the gate driver and a light-emitting element string unit and configured to convert and output a driving voltage of the light-emitting element string unit by the gate driver; a control circuit configured to control an operation of each component; a first low drop-out regulator configured to adjust a first input voltage to a first output voltage and output the first output voltage to the gate driver; a second low drop-out regulator configured to adjust a second input voltage to a second output voltage and output the second output voltage as a power source for the control circuit; a first switch configured to select any one of an external voltage or battery voltage and a first voltage and output the selected one to the first low drop-out regulator; a second switch configured to select any one of the external voltage or battery voltage and a second voltage and output the selected one to the second low drop-out regulator; and a feedback voltage selector configured to select an input voltage of at least one of the first and second low drop-out regulators according to levels of the first and second voltages, wherein the first and second voltages are voltages to which an output voltage of the power stage circuit is fed back or sensed, and wherein the second voltage is lower than a level of the first voltage and is input to an input terminal of the second switch to use as an operating power source of the control circuit.

### Advantageous Effects

Since the embodiment may select the input voltage of each of the low drop-out regulators according to the voltage level of the power management device, power consumption can be reduced. In particular, the output voltage of the power management device may be fed back or sensed and reused as the input voltage of each of the low drop-out regulators, and the size and power consumption of the control circuit can be reduced.

Since the embodiment may select the input voltage of each of the low drop-out regulators according to the sensed voltage level, power consumption can be reduced.

The embodiment may use the output of the low drop-out regulators as a control power source, so that the noise characteristics can be improved and the output change due to the power change can be reduced.

The embodiment may improve the reliability of the system or display device having the power management device by reducing the power consumption of the power management device having the low drop-out regulators.

### DESCRIPTION OF DRAWINGS

FIG. 1 is a block diagram of a power management device according to a first embodiment of the invention.

FIG. 2 is a waveform diagram of the input voltage and the output voltage of the second low drop-out regulator according to the level of the feedback voltage and the external voltage of FIG. 1.

FIG. 3 is a waveform diagram of the input voltage and the output voltage of the second low drop-out regulator when the level of the feedback voltage and the external voltage of FIG. is the first condition.

FIG. 4 is a waveform diagram of the input voltage and the output voltage of the second low drop-out regulator when the levels of the feedback voltage and external voltage of FIG. 1 are the second conditions.

FIG. 5 is a block diagram of a power management device according to a second embodiment of the invention.

FIG. 6 is a waveform diagram comparing the input voltage and the output voltage of the second low drop-out regulator according to the levels of the detection voltage and battery voltage of FIG. 5.

FIG. 7 is a waveform diagram comparing the input voltage and the output voltage of the second low drop-out regulator when the levels of the detection voltage and battery voltage of FIG. 5 are the first conditions.

FIG. 8 is a waveform diagram of the input voltage and the output voltage of the second low drop-out regulator when the levels of the detection voltage and battery voltage of FIG. 5 are the second conditions.

FIG. 9 is a configuration diagram showing an example of connecting a power management device and a light-emitting element string unit according to a third embodiment of the invention.

FIG. 10 is a configuration diagram showing an example of connecting a power management device and a light-emitting element string unit according to a fourth embodiment of the invention.

FIG. 11 is a configuration diagram showing another example of the power management device of FIG. 2.

FIG. 12 is a configuration diagram showing a power management device according to a fifth embodiment of the invention.

FIG. 13 is a configuration diagram showing a power management device, a driving driver, and a light-emitting element string unit according to a sixth embodiment of the invention.

FIG. 14 is a configuration diagram showing the input and output of the power management device according to an embodiment.

### MODE FOR INVENTION

Hereinafter, preferred embodiments of the present invention will be described in detail with reference to the attached drawings. The technical idea of the present invention is not limited to some of the embodiments described, but may be implemented in various different forms, and within the scope of the technical idea of the present invention, one or more of the components between the embodiments may be selectively combined or substituted and used. In addition, terms (comprising technical and scientific terms) used in the embodiments of the present invention may be interpreted as meanings that may be generally understood by a person having ordinary knowledge in the technical field to which the present invention belongs, unless they are clearly and specifically defined and described, and terms that are commonly used, such as terms defined in a dictionary, may be interpreted in consideration of the contextual meaning of the related technology.

In addition, the terms used in the embodiments of the present invention are for the purpose of describing the embodiments and are not intended to limit the present invention. In this specification, the singular may also comprise the plural unless specifically stated in the phrase, and when it is described as “at least one (or more than one) of A and (and) B, C,” it may comprise one or more of all combinations that may be combined with A, B, and C. In addition, when describing the components of the embodiments of the present invention, the terms first, second, A, B, (a), (b), etc. may be used. These terms are only for distinguishing the components from other components, and the nature, order, or sequence of the components are not determined by the terms. In addition, when it is described that a certain component is ‘connected’, ‘coupled’, or ‘joined’ to another component, the component may comprise not only cases where it is directly connected, coupled, or connected to the other component, but also cases where it is ‘connected’, ‘coupled’, or ‘joined’ by another component between the component and the other component. In addition, the various embodiments described below may be combined with each other unless specifically stated otherwise. In addition, any part omitted in the description of one of the various embodiments may be applied to the description of the other embodiments unless specifically stated otherwise. Hereinafter, the term “~unit” may be used interchangeably with “circuit,” “integrated circuit,” “block,” etc. For example, the term “power management unit” may be used interchangeably with the term “power management circuit,” “power management integrated circuit,” or “power management block.”

### First Embodiment

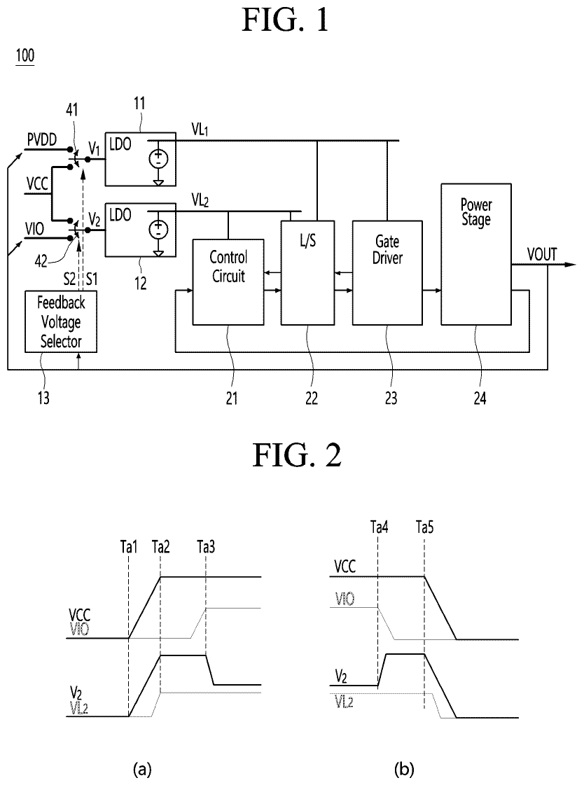

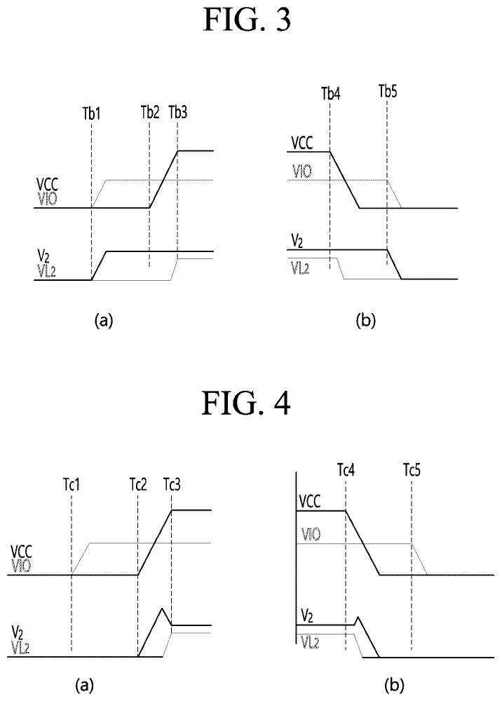

FIG. 1 is a block diagram of a power management device according to a first embodiment of the invention, FIG. 2 is a waveform diagram of input voltage and output voltage of a second low drop-out regulator according to the level of the feedback voltage and the external voltage of FIG. 1, FIG. 3 is a waveform diagram of input voltage and output voltage of a second low drop-out regulator when the level of the feedback voltage and the external voltage of FIG. 1 is a first condition, and FIG. 4 is a waveform diagram of input voltage and output voltage of a second low drop-out regulator when the level of the feedback voltage and the external voltage VCC of FIG. 1 is a second condition.

Referring to FIGS. 1 to 4, the power management device 100 may comprise a plurality of low drop-out regulators 11 and 12, a feedback voltage selector 13, a control circuit 21, a level shift circuit 22, a gate driver 23, a power stage circuit 24, and a plurality of switches 41 and 42.

The power management device 100 may manage and control power in an electronic device such as a laptop or a monitor. In addition, the power management device 100 may perform various functions such as battery management, power conversion, charging, and power consumption management. The power management device 100 may require a low operating voltage to reduce power consumption. For example, the power management device 100 may reuse the output voltage of the power management device 100 as a low drop-out regulator through feedback or input voltage sensing. The power management device 100 may be implemented as a power management IC (PMIC) that receives power and converts, rectifies, distributes, and controls the input voltage into a stable and efficient voltage or current required by the electronic device.

The plurality of low drop-out regulators 11 and 12 may be disposed in two or three or more in the power management device 100. The plurality of low drop-out regulators 11 and 12 may comprise first and second low drop-out regulators 11 and 12, and supply a stable output voltage with low noise. At least one of the plurality of low drop-out regulators 11 and 12 may be operated by a low input voltage. The LDO regulator is a linear regulator that operates even at a low input/output potential difference for a small-power power supply, and a relatively low input voltage may be selected to output the same voltage. Since the LDO regulator may select a low input voltage and operate at a low potential difference, energy loss can be reduced, thereby suppressing heat generation.

The input terminal of each of the plurality of low drop-out regulators 11 and 12 may be connected to a fixed terminal of each of the switches 41 and 42, and the output terminal thereof may be connected to circuit that requires the output voltage VL1 and VL2. For example, the input terminal of the first low drop-out regulator 11 may be connected to the output terminal of the first switch 41 to input a voltage selected through the first switch 41. The input terminal of the second low drop-out regulator 12 may be connected to the output terminal of the second switch 42 to input a voltage selected through the second switch 42.

The first switch 41 may select from among the first voltage PVDD and the external voltage VCC, and the second switch 42 may select from among the second voltage VIO and the external voltage VCC. The first and second voltages PVDD and VIO may be voltages to which the output voltage VOUT of the power management device 100 is fed back. For example, the first and second voltages PVDD and VIO may be voltages to which the voltage output from the power stage circuit 24 is fed back. The first and second voltages PVDD and VIO can be defined as recycled voltages because the output voltage within the power management device 100 or the output voltage VOUT of the power stage circuit 24 is reused.

The first voltage PVDD may be a voltage exceeding 1.8 V among the output voltages within the power management device 100, and may be in the range of, for example, 1.81 V to 5.5 V. The second voltage VIO may be a voltage lower than 1.8 V among the output voltages within the power management device 100, and may be in the range of, for example, 1.7 V to 1.8 V. The first voltage PVDD may be defined as a voltage higher than or as a high voltage than the external voltage VCC, and the second voltage VIO may be defined as a voltage lower than or as a low voltage than the external voltage VCC. The second voltage VIO may be a voltage having the smallest difference from the operating voltage of the control circuit 21 among the voltages output within the power management device 100.

The difference between the second voltage VIO and the external voltage VCC may be 1.55 V or less. For example, it may be in the range of 1.55 V to 1.4 V. Here, the external voltage VCC may be defined as a third voltage. The difference between the second voltage VIO and the operating voltage of the control circuit 21 may be 1 V or less, for example, 0.5 V or less.

One end of the first switch 41 may be connected to an output terminal of the power management device 100, for example, an output terminal of the power stage circuit 24, and the other end may be connected to an external voltage VCC terminal. One end of the second switch 42 may be connected to an output terminal of the power management device 100, for example, an output terminal of the power stage circuit 24, and the other end may be connected to an external voltage VCC terminal. One end and the other end of each of the first and second switches 41 and 42 may be input terminals. The feedback voltage selector 13 may be connected to a node (feedback node) connected to a feedback line of the output voltage VOUT in the power management device 100 to detect the level of the feedback voltage input through the feedback node and control the selection path of the switches 41 and 42 according to the detected voltage level.

The feedback voltage selector 13 may output a first selection signal S1 to the first switch 41 to select from among the first voltage PVDD, which is a feedback voltage, and an external voltage VCC, and the voltage selected through the first switch 41 may be input as the input voltage V1 of the first low drop-out regulator 15. The feedback voltage selector 13 may output a second selection signal S2 to the second switch 42 to select from among the second voltage VIO, which is a feedback voltage, and an external voltage VCC, and the voltage selected through the second switch 42 may be input as the input voltage V2 of the second low drop-out regulator 16.

In another example, the feedback voltage selector 13 may switchably connect the first switch 41 to the input terminal of the first voltage PVDD by using the first selection signal SI when the level of the feedback voltage is higher than a reference value, and the second switch 42 may be switchably connected to the input terminal of an external voltage VCC. The feedback voltage selector 13 may switchably connect the second switch 42 to the input terminal of a second voltage VIO when the level of the feedback voltage is lower than the reference value, and the first switch 41 may be switchably connected to the input terminal of the external voltage VCC. For example, when the feedback voltage exceeds 1.8V, the feedback voltage may be supplied to the input of the first low drop-out regulator 11 through the input terminal of the first switch 41. When the feedback voltage is 1.8V or lower, the feedback voltage may be supplied to the input of the second low drop-out regulator 12 through the input terminal of the second switch 42.

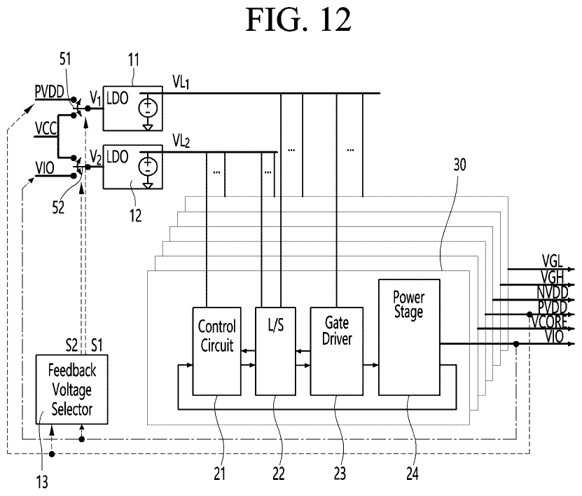

As another example, as illustrated in FIG. 12, when the output voltages VGL, VGH, NVDD, PVDD, VCORE, VIO, etc. of the plurality of power stage circuits 24 are output respectively, the feedback voltage selector 13 may feedback the first and second voltages PVDD and VIO among the output voltages, respectively, detect the levels of the first and second voltages PVDD and VIO, and control the selection of the first and second voltages PVDD and VIO input to the switches 51 and 52.

The criterion for selecting the first voltage PVDD in the feedback voltage selector 13 may be determined based on at least one or a combination of two or more of the following conditions: detection of the fed-back first voltage PVDD, a level code of the first voltage PVDD, a stabilized level of the first voltage PVDD, or whether the level of the first voltage PVDD satisfies a reference. Similarly, the criterion for selecting the second voltage VIO in the feedback voltage selector 13 may be determined based on at least one or a combination of two or more of the following conditions: detection of the fed-back second voltage VIO, a level code of the second voltage VIO, a stabilized level of the second voltage VIO, or whether the level of the second voltage VIO satisfies a reference. Alternatively, the feedback voltage selector 13 may control the system such that, if the feedback voltage is not the second voltage VIO, the first voltage PVDD is selected, and if the feedback voltage is not the first voltage PVDD, the second voltage VIO is selected.

The first low drop-out regulator 11 may output the first output voltage VL1 by adjusting the voltage V1 input through the first switch 41, and the second low drop-out regulator 12 may output the second output voltage VL2 by adjusting the voltage V2 input through the second switch 42. The first output voltage VL1 may be supplied to the level shift circuit 22 and the gate driver 23. Accordingly, the first output voltage VL1 of the first low drop-out regulator 11 may be provided as a driving power of the gate driver 23. Here, the range of the first output voltage VL1 may be changed according to the driving voltage of the gate driver 23.

The second low drop-out regulator 12 may supply the second output voltage VL2 to the control circuit 21 and the level shift circuit 22. Accordingly, the second output voltage VL2 of the second low drop-out regulator 12 may be provided as an operating power of the control circuit 21. Here, the range of the second output voltage VL2 may be changed according to the operating voltage of the control circuit 21. Here, when the control circuit 21 is designed to be 1.8 V, the input voltage V2 of the second low drop-out regulator 12 may be reused as a feedback voltage, thereby reducing the size of the control circuit 21 and reducing power consumption.

The first output voltage VL1 may output a voltage exceeding 1.8 V and may be lower than the first voltage PVDD or higher than the external voltage VCC. The second output voltage VL2 may be output as a voltage of 1.8 V or less or as a voltage of the second voltage VIO or less.

The control circuit 21 may operate based on the second output voltage VL2, comprise a CMOS circuit and be in charge of power management and control of each component. In addition, by comprising a CMOS circuit, the control circuit 21 may minimize power consumption and perform efficient power management. The control circuit 21 may control the operation of each component within the power management device 100, and the power stage circuit 24 may provide a feedback signal to the control circuit 21. The gate driver 23 may be connected to the level shift circuit 22. The level shift circuit 22 may convert voltage levels to respond to changes in input and output voltage levels, and may transmit signals between the control circuit 21 and gate driver 23 connected by comprising a CMOS circuit. The power stage circuit 24 may operate in response to a drive voltage output through the gate driver 23, adjust the input power, perform power conversion and management, and supply power required by each component.

The first and second low drop-out regulators 11 and 12 may operate in response to a high level of the external voltage VCC and may be turned off by a low level. The timing at which the first and second low drop-out regulators 11 and 12 operate or turn off may be linked according to the rising time (or section) or falling time (or section) of the external voltage VCC. To this end, the first and second low drop-out regulators 11 and 12 may communicate with a timing controller (not illustrated), and the input voltage may be adaptively changed by the feedback voltage selector 13 according to the timing of the external voltage VCC and the timing of the first and second voltages. As another example, the timing controller may be connected to the feedback voltage selector 13 and provide timing signals of the voltages to the feedback voltage selector 13. As another example, the timing controller may be connected to the feedback voltage selector 13 and the low drop-out regulators 11 and 12 to provide timing signals of the voltages to the feedback voltage selector 13 and the low drop-out regulators 11 and 12.

In FIGS. 2 to 4, the horizontal axis direction in each waveform diagram represents time, and the vertical axis represents a voltage level. FIG. 2(a) to 4(a) are waveform diagrams for explaining the level of the second input/output voltage according to the input time (or section) of the second input voltage of the second low drop-out regulator of FIG. 1, and FIG. 2(b) to 4(b) are waveform diagrams for explaining the level of the second input/output voltage according to the end time (or section) of the second input voltage V2 of the second low drop-out regulator of FIG. 1.

As illustrated in FIG. 1 and FIG. 2(a), when an external voltage VCC is input to the input terminal of the second switch 42 and then a second voltage VIO is input, the second input voltage V2 rises according to the level of the external voltage VCC at the input time Ta1 of the external voltage VCC, and the second output voltage VL2 is output at the rising time (or section) of the second input voltage V2 (Ta2). When the second voltage VIO is fed back or detected, the second voltage VIO is selected by the feedback voltage selector 13, and is input as the second input voltage V2 at the level of the second voltage VIO (Ta3), and at this time, the second output voltage VL2 is output at the level to which the second voltage VIO is adjusted. When the external voltage VCC is at a high level, the second low drop-out regulator 12 starts operating, and thereafter, the second low drop-out regulator 12 may continue operating in response to the fed-back second voltage VIO and output the second output voltage VL2.

As in FIG. 2(b) and FIG. 1, when the second voltage VIO falls at the input terminal of the second switch 42 and then the external voltage VCC falls, the second input voltage V2 is supplied by selecting the external voltage VCC at the time Ta4 when the second voltage VIO falls, and the second output voltage VL2 may fall when the external voltage VCC falls at the time Ta5. When the external voltage VCC is at a low level, the second low drop-out regulator 12 may be turned off.

As illustrated in FIG. 3(a) and FIG. 1, when the second voltage VIO is input to the input terminal of the second switch 42 and then the external voltage VCC is input, the second input voltage V2 is input at the level of the second voltage VIO until the external voltage VCC becomes the reference level (Tb1, Tb2), and the second output voltage VL2 may be output from the time Tb3 when the high level of the external voltage VCC starts. For example, when the second voltage VIO exceeds 1.7 V, the second input voltage V2 may be input at the second voltage VIO, and at this time, when the external voltage VCC is the reference level, the second low drop-out regulator 12 may be operated. Thereafter, the second low drop-out regulator 12 may continue to operate in response to the fed-back second voltage VIO and output the second output voltage VL2.

As illustrated in FIG. 3(b) and FIG. 1, when the external voltage VCC at the input terminal of the second switch 42 falls at a time Tb4 and then the second voltage VIO falls at a time Tb5, the second input voltage V2 may be input according to the second voltage VIO, and the second output voltage VL2 may fall at the falling time Tb5 of the external voltage VCC. When the external voltage VCC is at a low level, the second low drop-out regulator 12 may be turned off.

As illustrated in FIG. 4(a) and FIG. 1, when the second condition is that the second voltage VIO is input to the input terminal of the second switch 42 and then the external voltage VCC is input, even if the second voltage VIO rises to the reference level at time Tc1, the input of the second input voltage V2 is not performed, and when the external voltage VCC is input (Tc2), the second input voltage V2 is input according to the level of the external voltage VCC, and the second output voltage VL2 may be output from time Tc3 when the high level of the external voltage VCC starts. That is, when the external voltage VCC is lower than the reference level, the second input voltage V2 becomes the external voltage VCC. When the external voltage VCC exceeds the reference level and the second voltage VIO exceeds 1.7 V, the second input voltage V2 becomes the second voltage VIO. In addition, the second low drop-out regulator 12 may operate when the external voltage VCC exceeds the reference level.

As illustrated in FIG. 4(b) and FIG. 1, when the external voltage VCC at the input terminal of the second switch 42 falls at a time Tc4 and then the second voltage VIO falls at a time Tc5, the second input voltage V2 may fall according to the external voltage VCC, and the second output voltage VL2 may fall according to the falling time of the external voltage VCC. When the external voltage VCC is at a low level, the second low drop-out regulator 12 may be turned off.

In this way, the second low drop-out regulator 12 may operate in conjunction with the rising and falling times of the external voltage VCC, and the second input voltage V2 may be switched to a high level (external voltage level) or a low level depending on whether the detected second voltage VIO is input.

In addition, the first low drop-out regulator 11 may operate as illustrated in FIGS. 2 and 3 depending on the level of the first voltage PVDD and the level of the external voltage VCC, and the operation may be turned on/off depending on the rising and falling times of the external voltage VCC, and the first input voltage V1 may be switched to a high level (external voltage level) or a low level depending on whether the detected first voltage PVDD is input. By outputting the output voltages of the first and second low drop-out regulators 11 and 12 based on the selection of a feedback voltage, power consumption can be reduced, noise characteristics can be improved, and variations in output voltage due to power supply fluctuations can be minimized. In addition, the operational stability of the power management device can be enhanced.

Therefore, the feedback voltage selector 13 may adaptively control the input voltages PVDD, VCC and VIO of the first and second switches 41 and 42 according to the levels of the input voltages V1 and V2 of the first and second low drop-out regulators 11 and 12.

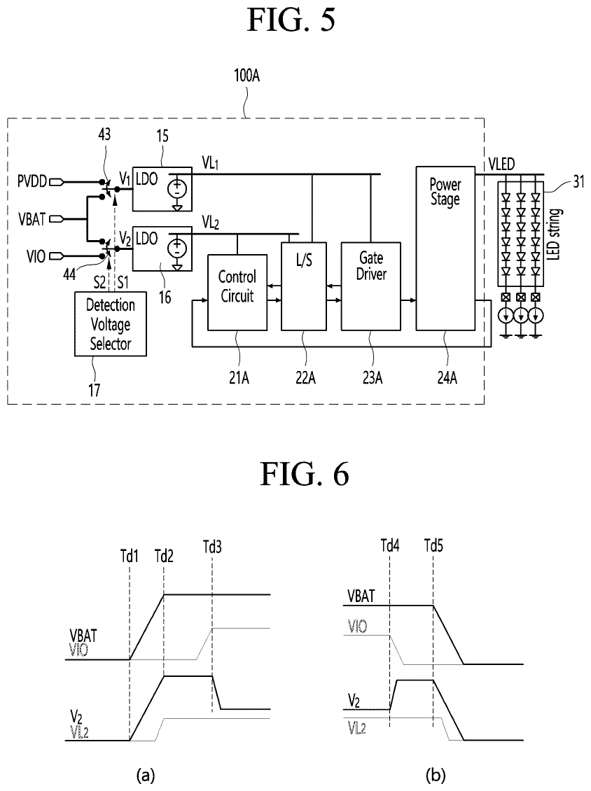

FIG. 5 is a block diagram of a power management device according to a second embodiment of the invention.

Referring to FIG. 5, the power management device 100A may comprise a plurality of low drop-out regulators 15 and 16, a detection voltage selector 17, a plurality of switches 43 and 44, a control circuit 21A, a level shift circuit 22A, a gate driver 23A, and a power stage circuit 24A. The control circuit 21A, the level shift circuit 22A, the gate driver 23A, and the power stage circuit 24A will refer to the description of FIG. 1.

The detection voltage selector 17 may be connected to lines of the first voltage PVDD, the battery voltage VBAT, and the second voltage VIO, or may detect the input of the voltages by a control signal. The detection voltage selector 17 may output selection signals S1 and S2 for selecting the first voltage PVDD, the battery voltage VBAT, and the second voltage VIO. The detection voltage selector 17 may sense and control the voltages of the input terminals of the switches 43 and 44, which are selectively input to the first and second low drop-out regulators 15 and 16, to select them.

The detection voltage selector 17 may output the first selection signal S1 to the first switch 43, and may select any one of the input voltages PVDD and VBAT. The detection voltage selector 17 may output the second selection signal S2 to the second switch 42, and may select any one of the input voltages VBAT and VIO.

The detection voltage selector 17 may detect a voltage similar to the operating voltage of the control circuit 21A and a voltage similar to or equal to the voltage for driving the gate driver 23A among the output voltages within the power management device 100A and control the same using selection signals S1 and S2, and the lines of the detected voltages may be reused by connecting them to the input terminals of the switches 15 and 16, respectively.

The first voltage PVDD may be higher than the second voltage VIO and lower than the battery voltage VBAT, and the second voltage VIO may be lower than the first voltage PVDD and 1.8 V or less. The battery voltage VBAT may be more than 5 V, for example, in the range of 6 V to 24 V, and may vary depending on the electronic product. The battery voltage VBAT may be defined as a fourth voltage.

When the first switch 43 selects one of the first voltage PVDD and the battery voltage VBAT by using the first selection signal S1, the selected voltage VI may be provided to the input terminal of the first low drop-out regulator 15. When the second switch 42 selects one of the battery voltage VBAT and the second voltage VIO by using the second selection signal S2, the selected voltage V2 may be provided to the input terminal of the second low drop-out regulator 16.

The first input voltage V1 of the first low drop-out regulator 15 may be a voltage selected by the first switch 43 from among the first voltage PVDD and the battery voltage VBAT, and the second input voltage V2 of the second low drop-out regulator 16 may be a voltage selected by the second switch 42 from among the battery voltage VBAT and the second voltage VIO.

A level shift circuit 22A and a gate driver 23A may be connected to an output terminal of the first low drop-out regulator 15, and a first output voltage VL1 of the first low drop-out regulator 15 may be input to the level shift circuit 22A and the gate driver 23A. A control circuit 21A and a level shift circuit 22A may be connected to an output terminal of the second low drop-out regulator 16, and a second output voltage VL2 of the second low drop-out regulator 16 may be input to the control circuit 21A and the level shift circuit 22A.

The first output voltage VL1 of the first low drop-out regulator 15 may output a voltage exceeding 1.8 V, and may be lower than the first voltage PVDD or lower than the battery voltage VBAT. The second output voltage VL2 of the second low drop-out regulator 16 may output a voltage of 1.8 V or less or a voltage or less of the second voltage VIO.

One end of the light-emitting element string unit 31 may be connected to the output terminal of the power management device 100A, and the light-emitting element string unit 31 may be turned on or off according to the power voltage VLED of the power stage circuit 24A, and a current source may be connected to the ground terminal. The light-emitting element string unit 31 may have input terminals of a plurality of LED strings connected to the output voltage terminal. The LED strings of the light-emitting element string unit 31 may each have a plurality of light-emitting elements (e.g., light-emitting diodes) connected in series, and the LED strings of the plurality of light-emitting element string units 31 may be connected in parallel with each other.

FIGS. 6 to 8 are waveform diagrams comparing the input voltage and the output voltage of the second low drop-out regulator according to the level of the detection voltage and the battery voltage VBAT of FIG. 5. In FIGS. 6 to 8, the horizontal axis direction in each waveform diagram represents time, and the vertical axis represents the voltage level. FIG. 6(a) to 8(a) are waveform diagrams for explaining the level of the second input/output voltage according to the start time of the second input voltage V2 of the second low drop-out regulator of FIG. 5, and FIG. 6(b) to 8(b) are waveform diagrams for explaining the level of the second input/output voltage according to the end time of the second input voltage V2 of the second low drop-out regulator of FIG. 5.

Referring to FIG. 6(a) and FIG. 5, when the battery voltage VBAT is input to the input terminal of the second switch 44 and then the second voltage VIO is input, the second input voltage V2 increases from the rising time Td1 of the battery voltage VBAT, and the second output voltage VL2 increases to a reference level during the rising time of the battery voltage VBAT and is output (Td2). Thereafter, when the second voltage VIO is input or detected (Td3), the second voltage VIO is selected by the detection voltage selector 17, the second input voltage V2 is input at the level of the second voltage VIO, and at this time, the second output voltage VL2 is output at the level to which the second voltage VIO is adjusted. When the battery voltage VBAT is at a high level, the second low drop-out regulator 16 starts operating. Thereafter, the second low drop-out regulator 16 may operate in response to the detected second voltage VIO and may output the second output voltage VL2.

As illustrated in FIG. 6(b) and FIG. 5, when the second voltage VIO falls at the input terminal of the second switch 44 and then the battery voltage VBAT falls, the second input voltage V2 is supplied by selecting the battery voltage VBAT at the time Td4 when the second voltage VIO falls, and the second output voltage VL2 may fall when the battery voltage VBAT falls at the time Td5. When the battery voltage VBAT is at a low level, the second low drop-out regulator 16 may be turned off.

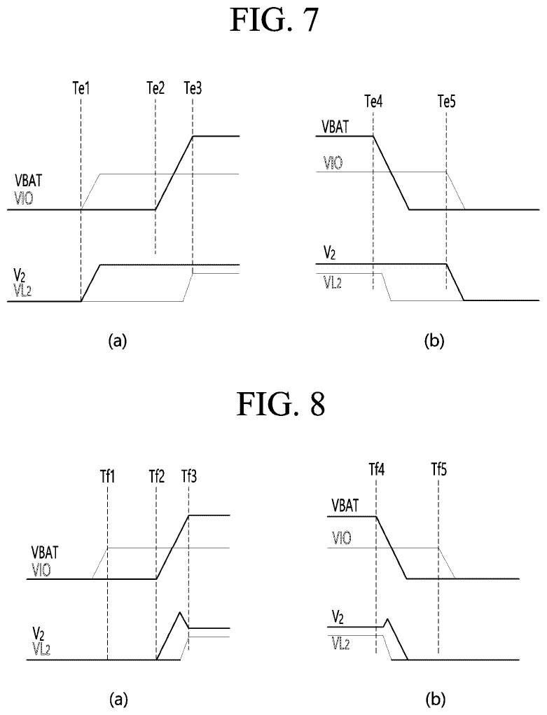

As illustrated in FIG. 7(a) and FIG. 5, when the first condition is that the second voltage VIO is input to the input terminal of the second switch 44 and then the battery voltage VBAT is input, the second input voltage V2 is input from the rising time Te1 of the second voltage VIO, and the second output voltage VL2 may be output from the time Te2 where the reference level of the battery voltage VBAT starts. For example, when the second voltage VIO exceeds 1.7 V, the second input voltage V2 is input at the level of the second voltage VIO, and at this time, when the battery voltage VBAT exceeds the threshold value (Te3), the second low drop-out regulator 16 may operate. Thereafter, the second low drop-out regulator 16 may continue to operate in response to the detected second voltage VIO and output the second output voltage VL2.

As illustrated in FIG. 7(b) and FIG. 5, when the external voltage VCC at the input terminal of the second switch 44 falls to the time Te4 and then the second voltage VIO falls to the time Te5, the second input voltage V2 is input according to the second voltage VIO, and the second output voltage VL2 may fall according to the drop of the battery voltage VBAT. When the external voltage VCC is at a low level, the second low drop-out regulator 16 may be turned off.

As illustrated in FIG. 8(a) and FIG. 5, when the second condition is that the second voltage VIO is input to the input terminal of the second switch 44 and then the battery voltage VBAT is input, the second input voltage V2 is at a low level until the time Tf2 when the battery voltage VBAT starts, even if the second voltage VIO is input at the time (Tf1), and the second output voltage VL2 may be output from the time Tf3 when the high level of the battery voltage VBAT starts. For example, when the battery voltage VBAT is below the reference level, the second input voltage V2 becomes the battery voltage VBAT. When the battery voltage VBAT is equal to or higher than the reference level and the second voltage VIO exceeds 1.7 V, the second input voltage V2 becomes the second voltage VIO. In addition, the second low drop-out regulator 16 may operate when the battery voltage VBAT is equal to or higher than the reference level. Thereafter, the second low drop-out regulator 16 may operate in response to the second voltage VIO and output the second output voltage VL2.

As illustrated in FIG. 8(b) and FIG. 5, when the battery voltage VBAT at the input terminal of the second switch 44 falls at a time Tf4 and then the second voltage VIO falls at a time Tf5, the second input voltage V2 may fall according to the battery voltage VBAT, and the second output voltage VL2 may fall according to the falling time of the battery voltage VBAT. When the battery voltage VBAT is at a low level, the second low drop-out regulator 16 may be turned off.

In this way, the operation of the second low drop-out regulator 16 may be controlled at the rising and falling times of the battery voltage VBAT, and the second input voltage V2 may be switched to a high level (level of battery voltage) or a low level depending on whether the detected second voltage VIO is input.

In addition, the first low drop-out regulator 15 may operate as illustrated in FIGS. 6 to 8 according to the detection results of the first voltage PVDD and the battery voltage VBAT, and may be turned on/off by the rising and falling times of the battery voltage VBAT, and the first input voltage V1 may be switched to a high level (level of battery voltage) or a low level depending on whether the detected first voltage PVDD is input. By outputting the output voltages of the first and second low drop-out regulators 15 and 16 based on the selection of a sensing voltage, power consumption can be reduced, noise characteristics can be improved, and variations in output voltage due to changes in the power supply can be minimized. In addition, the operational stability of the power management device can be enhanced.

Therefore, the detection voltage selector 17 may adaptively control the input voltages PVDD, VBAT and VIO of the first and second switches 43 and 44 to change the input voltages V1 and V2 of the first and second low drop-out regulators 11 and 12.

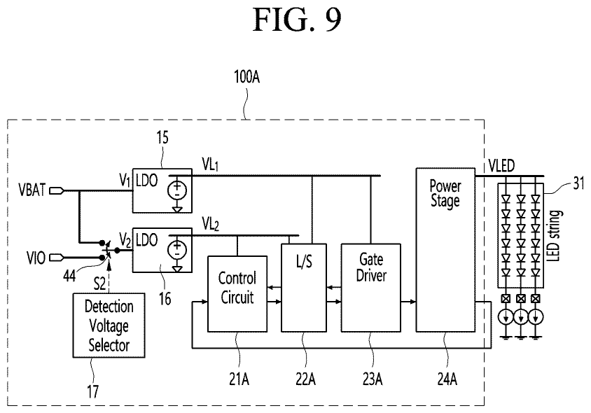

FIG. 9 is a diagram showing an example of a power management device according to a third embodiment.

Referring to FIG. 9, the power management device 100A may supply a power voltage VLED for driving a load, for example, a light-emitting element string unit 31. In the power management device 100A, the first input voltage V1 of the first low drop-out regulator 15 may be connected to a terminal of the battery voltage VBAT, and the second input voltage V2 of the second low drop-out regulator 16 may be connected to an output terminal of the switch 44. The input terminal of the switch 44 may be connected to the terminal of the battery voltage and the terminal of the detection voltage. The switch 44 may select the battery voltage VBAT or the detection voltage VIO by using the selection signal S2 of the voltage selection unit 17, and the second input voltage V2 of the second low drop-out regulator 16 may be operated through the selection voltage of the switch 44. The detection voltage may be a voltage of 1.8 V or less, and when the detection voltage is selected, the second low drop-out regulator 16 may be operated by using the detection voltage, so that power consumption can be reduced.

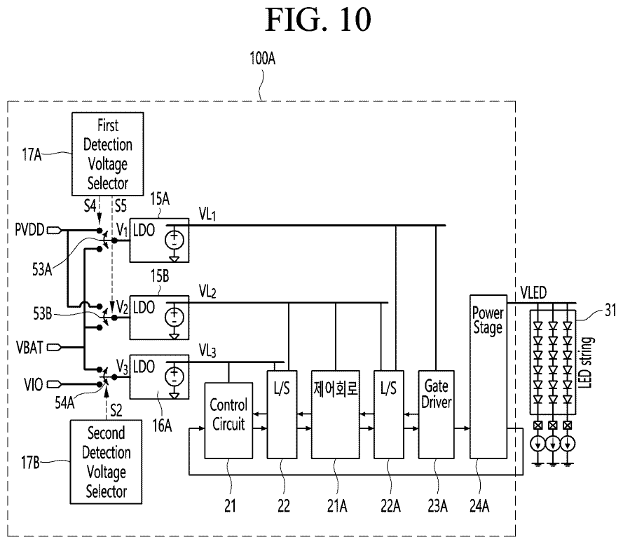

FIG. 10 is a drawing showing an example of a power management device according to a fourth embodiment. In explaining the fourth embodiment, the components of the first to third embodiments are the same, and redundant descriptions will be omitted.

Referring to FIG. 10, the power management device 100A may supply a power voltage required for a load or a device, and may supply, for example, a power voltage VLED for driving a light-emitting element string unit 31.

The power management device 100A may comprise a plurality of low drop-out regulators 15A, 15B, and 16A, control circuits 21 and 21A, level shift circuits 22 and 22A, a gate driver 23A, a power stage circuit 24A, a plurality of switches 53A, 53B, and 54A, and detection voltage selectors 17A and 17B.

The low drop-out regulators may comprise first to third low drop-out regulators 15A, 15B and 16A, the plurality of switches comprises first to third switches 53A, 53B and 54A, and the detection voltage selectors comprises first and second detection voltage selectors 17A and 17B.

The first switch 53A may select from among a first voltage PVDD and a battery voltage VBAT by using the selection signal S4 of the first detection voltage selector 17A, and the voltage selected by the first switch 53A may be input as a first input voltage V1 of the first low drop-out regulator 15A. The first low drop-out regulator 15A may supply a first output voltage VL1, which is a power voltage of a second level shift circuit 22A and a gate driver 23A, by adjusting the first input voltage V1. The gate driver 23A may control the operation of the power stage circuit 24A, and the power stage circuit 24A may provide the power voltage VLED required by the load, i.e., the light-emitting element string unit 31.

The second switch 53B may select from among the first voltage PVDD and the battery voltage VBAT by using the selection signal S5 of the first detection voltage selection section 17A, and the voltage selected by the second switch 53B may be input as the second input voltage V2 of the second low drop-out regulator 15B. The second low drop-out regulator 15B may adjust the second input voltage V2 to supply the second output voltage VL2, which is the power voltage of the first level shift circuit 22, the second control circuit 22A, and the second level shift circuit 24A.

The third switch 54A may select from among the second voltage VIO and the battery voltage VBAT by using the selection signal S2 of the second detection voltage selector 17B, and the voltage selected by the third switch 54A may be input as the third input voltage V3 of the third low drop-out regulator 16A. The third low drop-out regulator 16A may adjust the third input voltage V3 to supply the third output voltage VL3, which is the power supply voltage of the first control circuit 21 and the first level shift circuit 22.

The first and second low drop-out regulators 15A and 15B may provide power to components that use voltages exceeding 1.8V. The output voltages of the first and second low drop-out regulators 15A and 15B may exceed 1.8 V and may be at the same level or different levels. Accordingly, the voltage required for various high-voltage (exceeding 1.8 V) components may be stably supplied through the first and second low drop-out regulators 15A and 15B. The third low drop-out regulator 16A may provide power to components 21 and 22 or low-voltage components that use voltages of 1.8 V or less.

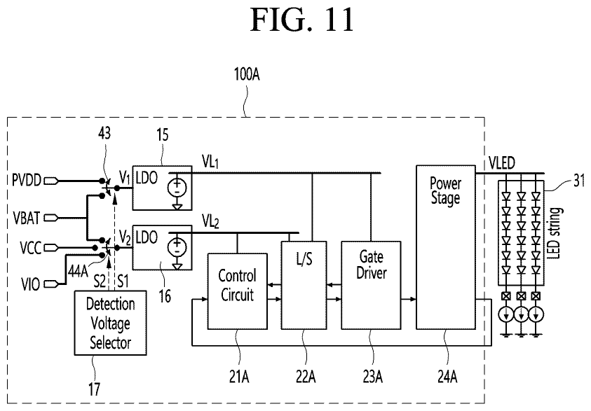

FIG. 11 is a configuration diagram of a power management device showing another example of FIG. 2.

Referring to FIG. 11, the first switch 43 may provide one of the first voltage PVDD and the battery voltage VBAT as the first input voltage V1 of the first low drop-out regulator 15. The first low drop-out regulator 15 may adjust a high voltage, for example, an input voltage exceeding 1.8 V, to provide a first output voltage VL1 to the level shift circuit 22A and the gate driver 23A.

The second switch 44A may select one of the battery voltage VBAT, the external voltage VCC, and the second voltage VIO, and provide it as the second input voltage of the second low drop-out regulator 16. The second switch 44A may be connected to lines of at least three different levels of voltages VBAT, VCC, and VIO to select and provide one of the three voltages VBAT, VCC, and VIO. When the second switch 44A cannot use the low voltage within the power management device 100A, that is, the feedback voltage or the sensing voltage, a terminal of the external voltage VCC lower than the battery voltage VBAT may be additionally added, and the second switch 44A may select from among the battery voltage VBAT and the external voltage VCC.

The second low drop-out regulator 16 may have its on/off timing controlled by the battery voltage VBAT. In the on-state, the second low drop-out regulator 16 may adjust and output a second output voltage VL2 of 1.8V or less based on the external voltage VCC. Accordingly, since the second low drop-out regulator 16 adjusts the input to the second output voltage VL2 using a voltage lower than the battery voltage VBAT, power consumption can be reduced.

FIG. 12 is a configuration diagram showing a power management device according to a fifth embodiment of the invention. In explaining the fifth embodiment, the same components in the first and second embodiments are referred to in the descriptions of the first and second embodiments, and redundant descriptions are omitted.

Referring to FIG. 12, the power management device may comprise a plurality of power management units 30, and each of the plurality of power management units 30 may comprise a control circuit 21, a level shift circuit 22, a gate driver 23, and a power stage circuit 24.

The output terminals of the plurality of power management units 30 may output voltages of different levels VGL, VGH, NVDD, PVDD, VCORE, and VIO. The output terminals of the plurality of power management units 30 may output, for example, a first voltage PVDD, a second voltage VIO, and voltages of high or low levels.

The input terminal of the first switch 51 may be connected to terminals of the first voltage PVDD and an external voltage VCC, and the output terminal thereof may be connected to an input terminal of the first low drop-out regulator 11. The input terminal of the second switch 52 may be connected to the terminals of the second voltage VIO and the external voltage VCC, and the input terminal of the second low drop-out regulator 12 may be connected to the output terminal.

The feedback voltage selector 13 may feedback the first voltage PVDD and the second voltage VIO, and may be controlled by using the selection signal S1 of the first switch 51 according to the level of the fed-back first voltage PVDD, and may be controlled by using the selection signal S2 of the second switch 52 according to the level of the fed-back second voltage VIO. The first low drop-out regulator 11 may operate by the external voltage VCC or the first voltage PVDD input as the first input voltage V1, and may be adjusted to the first output voltage VL1 exceeding 1.8. The second low drop-out regulator 12 may operate by an external voltage VCC or a second voltage VIO input as a second input voltage V2, and may be adjusted to a second output voltage VL2 of 1.8 or less. Since the second output voltage VL2 is adjusted to a low voltage second input voltage V2, power consumption can be reduced. The first and second voltages PVDD and VIO may be voltages output through the power management unit 30 and sensed by the detection voltage selector 17.

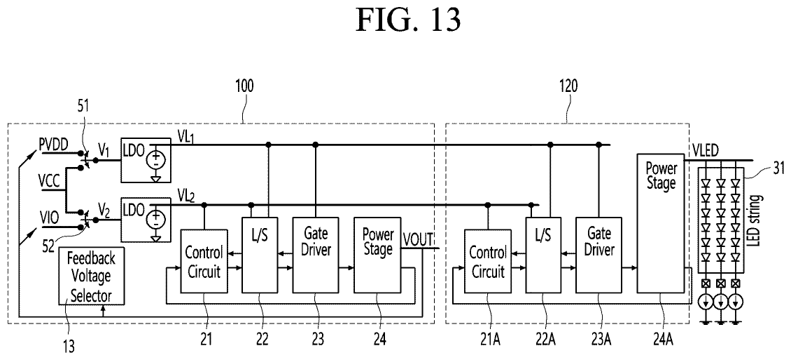

FIG. 13 is a configuration diagram showing a power management device, a driving driver, and a light-emitting element string unit according to a sixth embodiment of the invention.

Referring to FIG. 13, the power management device 100 may be connected to a driving driver 120. The driving driver 120 may comprise a light-emitting element driver, for example, an LED driver. The driving driver 120 may comprise a power management circuit, for example, a second control circuit 21A, a second level shift circuit 22A, and a second gate driver 23A.

The first low drop-out regulator 11 of the power management device 100 may operate by receiving a voltage selected from the first voltage PVDD and the external voltage VCC, and may adjust it to the first output voltage VL1.

The first output voltage VL1 of the first low drop-out regulator 11 of the power management device 100 may be supplied to the first level shift circuit 22 and the first gate driver 23 of the power management device 100, and the second level shift circuit 22A and the second gate driver 23A of the driving driver 120. The second gate driver 23A may be driven by the first output voltage VL1 to provide power required for the light-emitting element string unit 31 through the power stage circuit 24A.

The second low drop-out regulator 13 of the power management device 100 may operate by receiving a voltage selected from the second voltage VIO and the external voltage VCC, and may adjust it to the second output voltage VL2.

The second output voltage VL2 of the second low drop-out regulator 13 of the power management device 100 may be supplied to the first control circuit 21 and the first level shift circuit 22 within the power management device 100. The second low drop-out regulator 13 may be adjusted to the second output voltage VL2 by the second voltage VIO, which is a low voltage, so that it may be selected according to the level of the feedback voltage, thereby reducing power consumption.

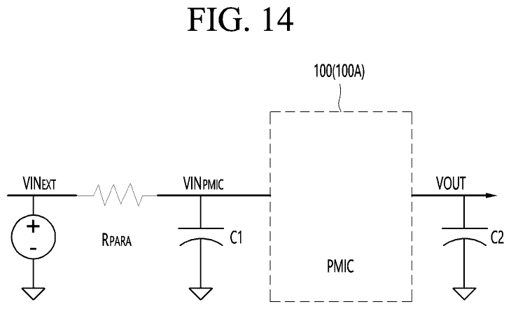

FIG. 14 is a schematic diagram conceptually showing the input and output of the power management device according to an embodiment.

Referring to FIG. 14, in power management devices 100 and 100A, the input voltage VINEXT may be voltage-dropped by the parasitic resistance RPARA, the voltage VINPMIC may be stabilized through the first capacitor C1, and may be adjusted to the first or second output voltage disclosed above, and the required voltage may be output through the power stage circuit, and noise can be removed by the second capacitor C2.

As in FIG. 1, for example, when the control circuit 21 is a 1.8 V element, the size and power consumption of the second low drop-out regulator 12 can be reduced, and heat generation may also be reduced. When consuming 1 mA, the power consumption is 3.3 mW (=3.3V*1 mA) when the input is 3.3V, but when the input is 1.8V, the power consumption can be reduced to 1.8 mW (=1.8V*1 mA).

In addition, since the output of the second low drop-out regulator 12 is used as the power supply of the control circuit 21, the influence of the power supply can be reduced, enabling a stable supply, and the noise characteristic can be strengthened and the change in the output according to the change in the power supply can be reduced. In addition, since the power consumption is reduced, the voltage dropout for the external voltage VCC can be reduced, the voltage stability can be increased, and the voltage margin can be improved.

The present specification is not limited to the embodiments exemplified herein. Rather, these embodiments are provided as examples to make this disclosure thorough and complete, and will fully convey the features and functions of the present invention to those skilled in the art. Accordingly, processes, elements, and techniques that are not necessary for a person skilled in the art to fully understand the features and functions of the present invention may not be described. Unless specifically stated otherwise, similar reference numerals designate similar components in the accompanying drawings and written description, and thus the description thereof will not be repeated.

1. A power management device, comprising,
a level shift circuit;
a gate driver;
a power stage circuit connected to the gate driver and configured to convert power required for a load to output an output voltage;
a control circuit configured to control an operation of each component;
a first low drop-out regulator configured to adjust a first input voltage to a first output voltage and output the first output voltage to the gate driver;
a second low drop-out regulator configured to adjust a second input voltage to a second output voltage and output the second output voltage as a power source for the control circuit;
a feedback voltage selector configured to select an input voltage of at least one of the first and second low drop-out regulators according to an external voltage or battery voltage and a level of the output voltage of the power stage circuit; and
a switch configured to switch and select from among the external voltage or battery voltage and the output voltage fed back from the power stage circuit in response to a selection signal of the feedback voltage selector.

2. The power management device of claim 1, wherein the second input voltage of the second low drop-out regulator is the output voltage fed back from the power stage circuit, and has a voltage lower than a level of the external voltage.

3. The power management device of claim 1, wherein the feedback voltage selector is configured to control the switch to set a rising time of the second output voltage of the second low drop-out regulator as an input time of the external voltage or the battery voltage.

4. The power management device of claim 3, wherein the feedback voltage selector is configured to control the switch to set a falling time of the second output voltage of the second low drop-out regulator as an end time of the external voltage or the battery voltage.

5. The power management device of claim 1, wherein the output voltage fed back from the power stage circuit is a first voltage higher than the level of the external voltage, and
wherein the switch comprises a first switch configured to select one of the external voltage and the first voltage by the feedback voltage selector and is configured to provide the selected one as the first input voltage of the first low drop-out regulator.

6. The power management device of claim 5, wherein the output voltage of the power stage circuit is a second voltage lower than the level of the external voltage and a level of the first voltage, and
wherein the switch comprises a second switch configured to select one of the external voltage and the second voltage by the feedback voltage selector and is configured to provide the selected one as the second input voltage of the second low drop-out regulator.

7. The power management device of claim 6, wherein the second voltage is 1.8 V or less, and a level difference between the second voltage and an operating voltage of the control circuit is 0.5 V or less.

8. The power management device of claim 1, wherein the output voltage of the power stage circuit is a first voltage lower than a level of the battery voltage, and
wherein the switch comprises a first switch configured to select one of the battery voltage and the first voltage by the feedback voltage selector and is configured to provide the selected one as the first input voltage of the first low drop-out regulator.

9. The power management device of claim 8, wherein the output voltage fed back from the power stage circuit is a second voltage lower than the level of the battery voltage and a level of the first voltage,
wherein the switch comprises a second switch configured to select one of the battery voltage and the second voltage by the feedback voltage selector and is configured to provide the selected one as a second input voltage of the second low drop-out regulator, and
wherein the second voltage is 1.8 V or less, and a level difference between the second voltage and the operating voltage of the control circuit is 0.5 V or less.

10. A power management device, comprising:
a level shift circuit;
a gate driver;
a power stage circuit connected between the gate driver and a light-emitting element string unit and configured to convert and output a driving voltage of the light-emitting element string unit by the gate driver;
a control circuit configured to control an operation of each component;
a first low drop-out regulator configured to adjust a first input voltage to a first output voltage and output the first output voltage to the gate driver;
a second low drop-out regulator configured to adjust a second input voltage to a second output voltage and output the second output voltage as a power source for the control circuit;
a first switch configured to select any one of an external voltage or battery voltage and a first voltage and output the selected one to the first low drop-out regulator;
a second switch configured to select any one of the external voltage or battery voltage and a second voltage and output the selected one to the second low drop-out regulator; and
a feedback voltage selector configured to select an input voltage of at least one of the first and second low drop-out regulators according to levels of the first and second voltages,
wherein the first and second voltages are voltages to which an output voltage of the power stage circuit is fed back or sensed, and wherein the second voltage is lower than a level of the first voltage and is input to an input terminal of the second switch to use as an operating power source of the control circuit.

11. The power management device of claim 2, wherein the output voltage fed back from the power stage circuit is a first voltage higher than the level of the external voltage, and
wherein the switch comprises a first switch configured to select one of the external voltage and the first voltage by the feedback voltage selector and is configured to provide the selected one as the first input voltage of the first low drop-out regulator.

12. The power management device of claim 3, wherein the output voltage fed back from the power stage circuit is a first voltage higher than the level of the external voltage, and
wherein the switch comprises a first switch configured to select one of the external voltage and the first voltage by the feedback voltage selector and is configured to provide the selected one as the first input voltage of the first low drop-out regulator.

13. The power management device of claim 4, wherein the output voltage fed back from the power stage circuit is a first voltage higher than the level of the external voltage, and
wherein the switch comprises a first switch configured to select one of the external voltage and the first voltage by the feedback voltage selector and is configured to provide the selected one as the first input voltage of the first low drop-out regulator.

14. The power management device of claim 2, wherein the output voltage of the power stage circuit is a first voltage lower than a level of the battery voltage, and
wherein the switch comprises a first switch configured to select one of the battery voltage and the first voltage by the feedback voltage selector and is configured to provide the selected one as the first input voltage of the first low drop-out regulator.

15. The power management device of claim 3, wherein the output voltage of the power stage circuit is a first voltage lower than a level of the battery voltage, and
wherein the switch comprises a first switch configured to select one of the battery voltage and the first voltage by the feedback voltage selector and is configured to provide the selected one as the first input voltage of the first low drop-out regulator.

16. The power management device of claim 4, wherein the output voltage of the power stage circuit is a first voltage lower than a level of the battery voltage, and
wherein the switch comprises a first switch configured to select one of the battery voltage and the first voltage by the feedback voltage selector and is configured to provide the selected one as the first input voltage of the first low drop-out regulator.
